(19) United States
(12) Patent Application Publication
(10) Pub. No.: US 2015/0120439 A1
(43) Pub. Date: Apr. 30, 2015

(54) MAILING LABEL ADVERTISING SYSTEM

(71) Applicant: Chris Gilliam, Dallas, TX (US)

(72) Inventor: Chris Gilliam, Dallas, TX (US)

(21) Appl. No.: 14/069,319

(22) Filed: Oct. 31, 2013

(51) Int. Cl. G06Q 30/02; G06K 15/02

(52) U.S. Cl. CPC G06Q 30/0251; G06K 15/024
USPC 705/14.49

(57) ABSTRACT

The invention disclosed herein provides apparatuses, systems and method for highly targeted advertising. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims. 37 CFR 1.72(b).

### CLAIM OF PRIORITY

The invention is related to and claims priority from U.S. Provisional Patent Application No. 61/795,883 filed Oct. 31, 2012 to common inventor Gillium, and entitled Mailing Label Advertising System.

### TECHNICAL FIELD OF THE INVENTION

The invention relates generally to advertising systems.

### PROBLEM STATEMENT

### Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

### Discussion

Americans are saturated with advertisements. According to one study, the average person views more than 2,500 advertisements each day. Clearly, most are not remembered, and a great many—especially online advertisements—are not even “eyeballed” by the consumer. Indeed, it is commonly accepted in the industry that an advertisement needs a minimum of seven impressions to enjoy a place in the mind of the consumer. To get a consumer to actually take action based on an advertisement is even tougher. What advertisers need are systems, methods and devices that deliver the right ad to the right consumer at the right time and in the right place, and to give the consumer a meaningful way to interact with the ad in a way that benefits the consumer and the advertiser, and the present invention provides such.

### BRIEF DESCRIPTION OF THE DRAWINGS AND TABLE

Various aspects of the invention, as well as an embodiment, are better understood by reference to the following detailed description. To better understand the invention, the detailed description should be read in conjunction with the drawings and tables (if any).

FIG. 1 shows an inventive algorithm.

FIG. 2 shows an inventive architecture.

FIG. 3 shows exemplary application functionality.

FIG. 4 shows application analytics.

FIG. 5 shows an application administration tab.

FIG. 6 shows additional administration functionality.

FIG. 7 shows a second additional administrative functionality.

FIG. 8 shows a third additional administrative functionality.

FIG. 9 shows a fourth additional administrative functionality.

FIG. 10 shows a fifth additional administrative functionality.

FIG. 11 shows a sixth additional administrative functionality.

FIG. 12 shows a seventh additional administrative functionality.

FIG. 13 shows an eighth additional administrative functionality.

FIG. 14 shows a ninth additional administrative functionality.

FIG. 15 shows a demographic—influences for advertisement delivery.

FIG. 16 shows add campaign functionality.

FIG. 17. shows campaign tab functionality.

FIG. 18 shows a second campaign tab functionality.

FIG. 19 shows an alternative administrative tab.

FIG. 20 shows an exemplary shipping label.

FIG. 21 shows an alternative exemplary shipping label.

### DETAILED DESCRIPTION OF THE INVENTION

### Interpretation Considerations

When reading this section (which describes an exemplary embodiment of the best mode of the invention, hereinafter “exemplary embodiment”), one should keep in mind several points. First, the, following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “attaching” may be done by hook-and-loop attachment (such as Velcro®), snaps, hooks, belts, etc., and so a use of the word attaching invokes all methods of attachment known in and anticipated by the art, and all other modes of that word and similar words).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for—functioning—” or “step for—functioning—” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise.

It should be noted in the following discussion that acts with like names are performed in like manners, unless otherwise stated. Of course, the foregoing discussions and definitions are provided for clarification purposes and are not limiting. Words and phrases are to be given their ordinary plain meaning unless indicated otherwise. The numerous innovative teachings of present application are described with particular reference to presently preferred embodiments.

### DESCRIPTION OF THE DRAWINGS

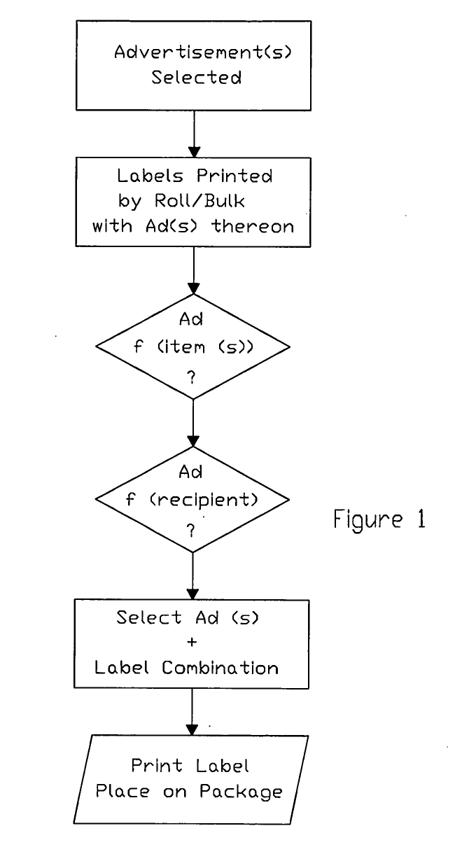

FIG. 1 illustrates one embodiment of the invention as an advertisement selection algorithm (the algorithm). The algorithm begins with an advertisement selected act in which the advertisement(s) to be placed are determined. Then, in a labels printed act, advertisements are printed in bulk form on labels. Next, in an Ad f(item) act, an advertisement/label may be paired with a particular item/good being shipped. Then, in an Ad f(recipient) act, an advertisement/label may be paired with the individual and/or household receiving the package. The prior acts culminate in the algorithm selecting the advertisement that is the best fit for the recipient based also on the item being shipped, which in turn increases advertiser effectiveness. Next, the printed label is affixed to the appropriate package(s).

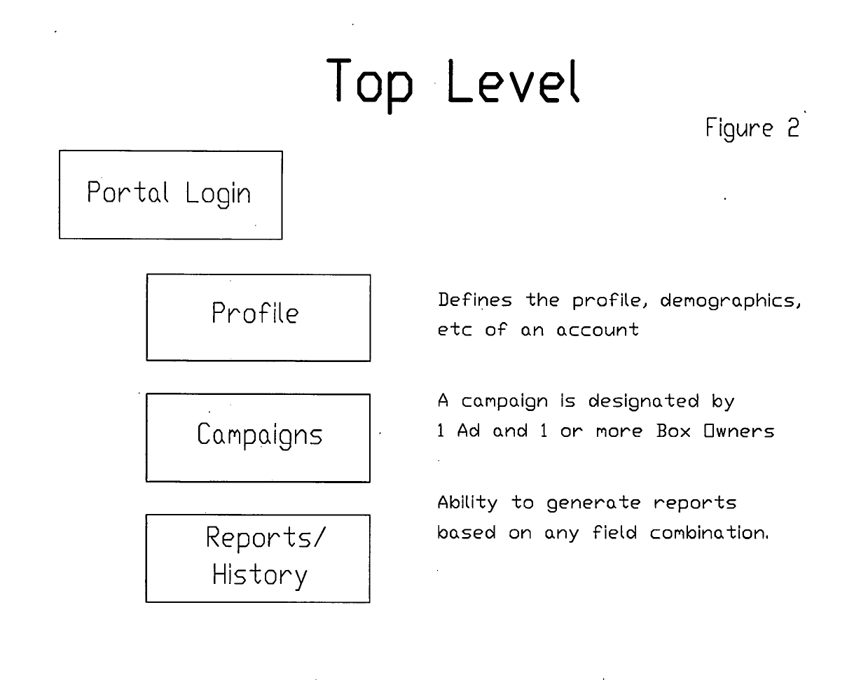

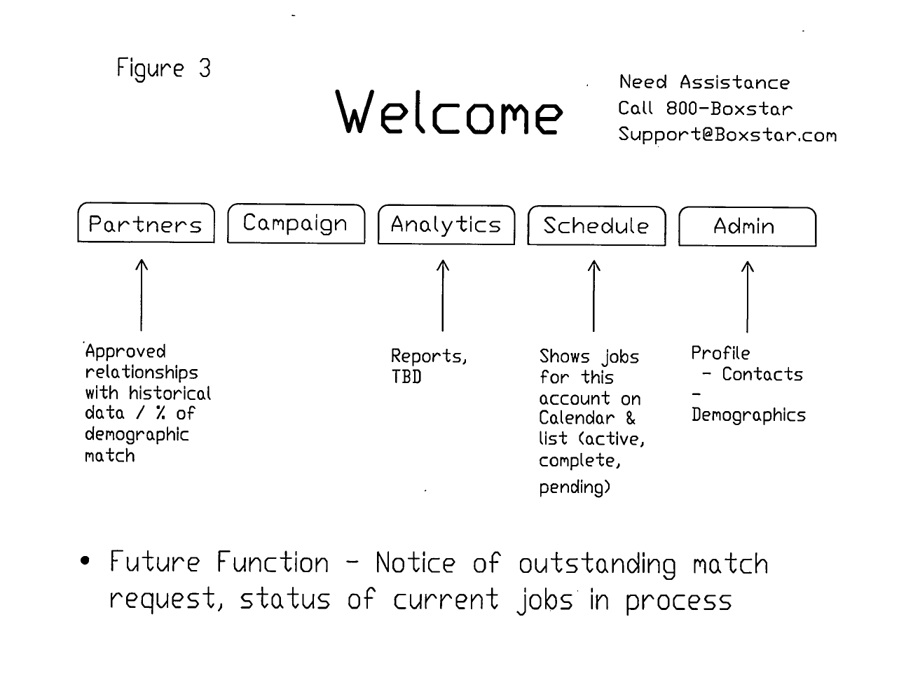

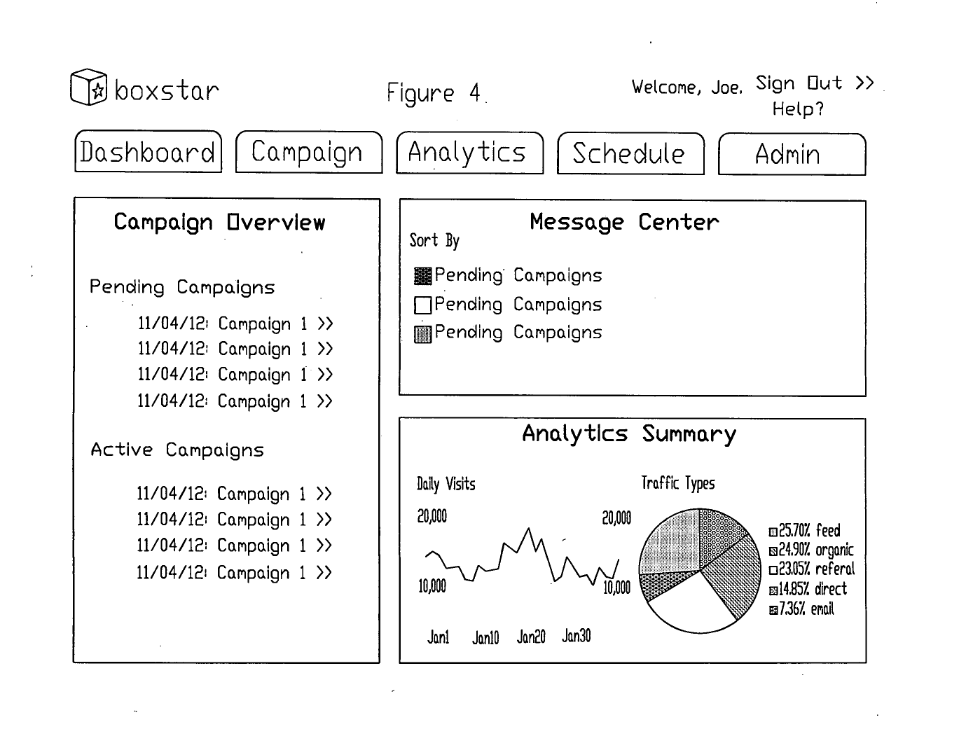

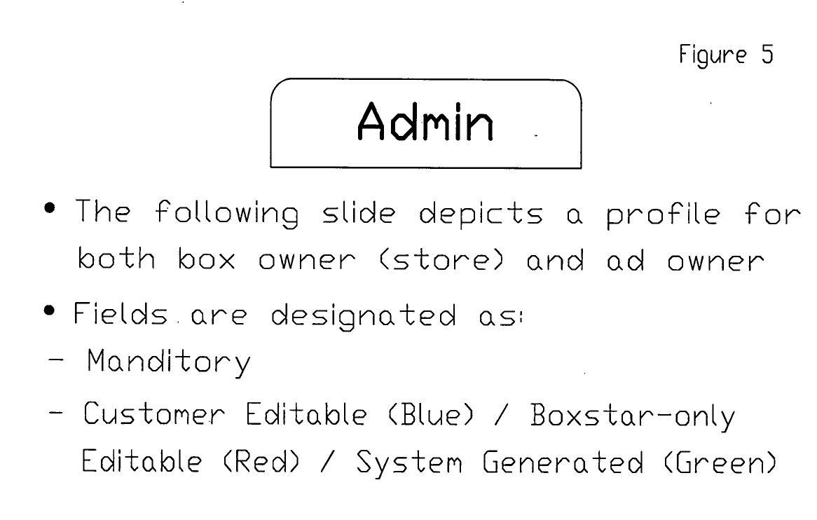

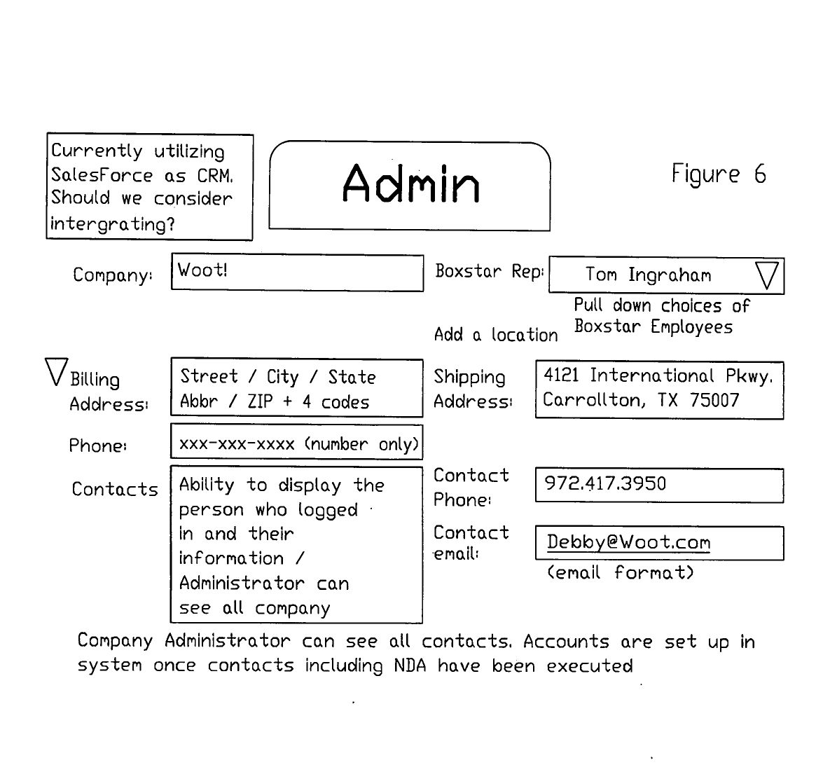

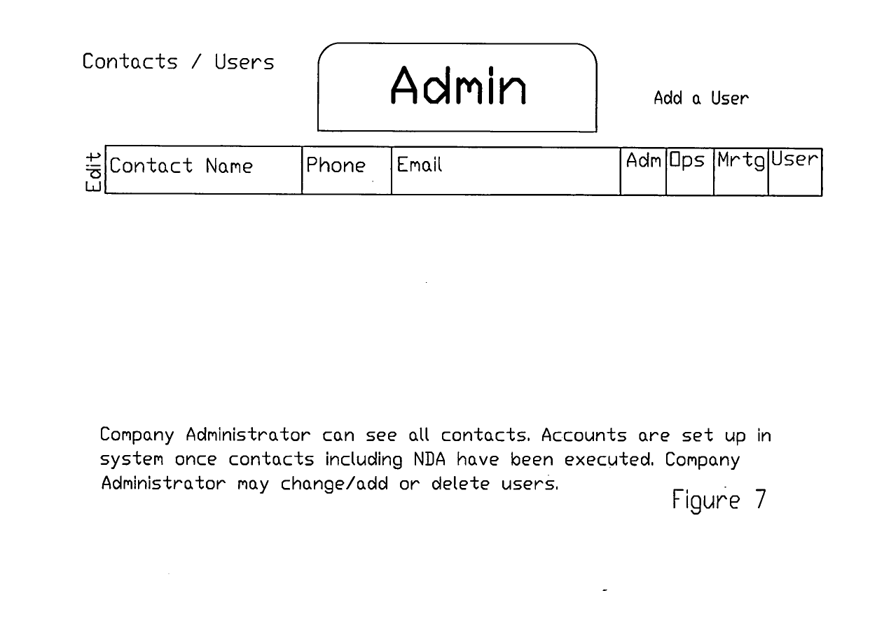

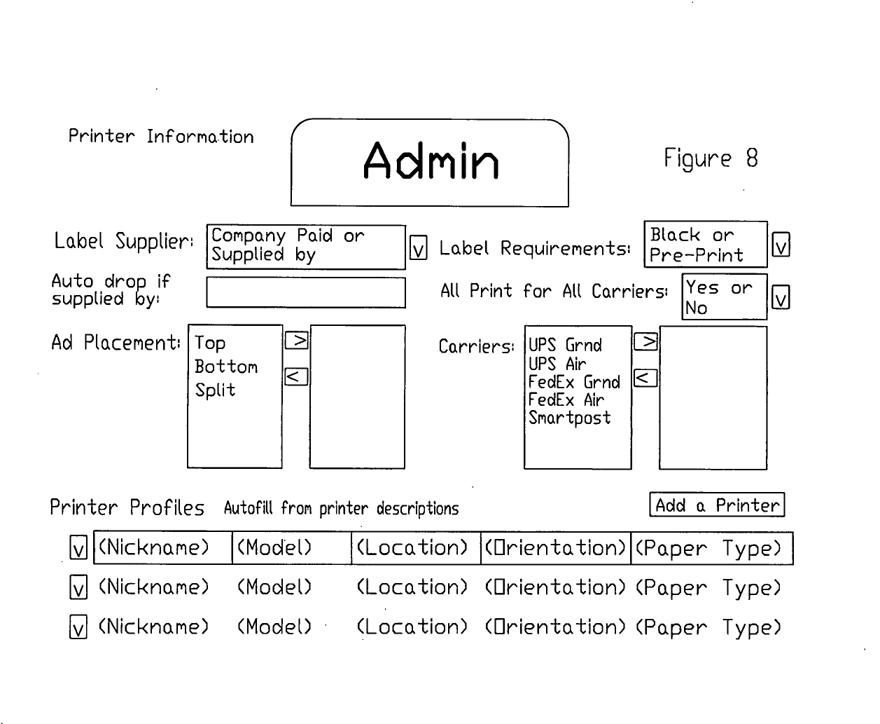

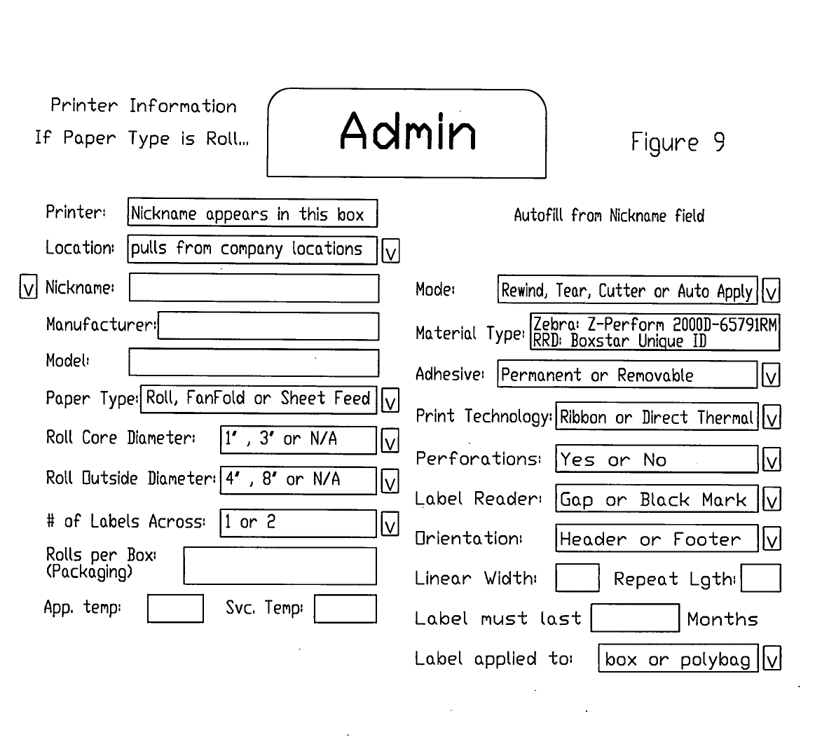

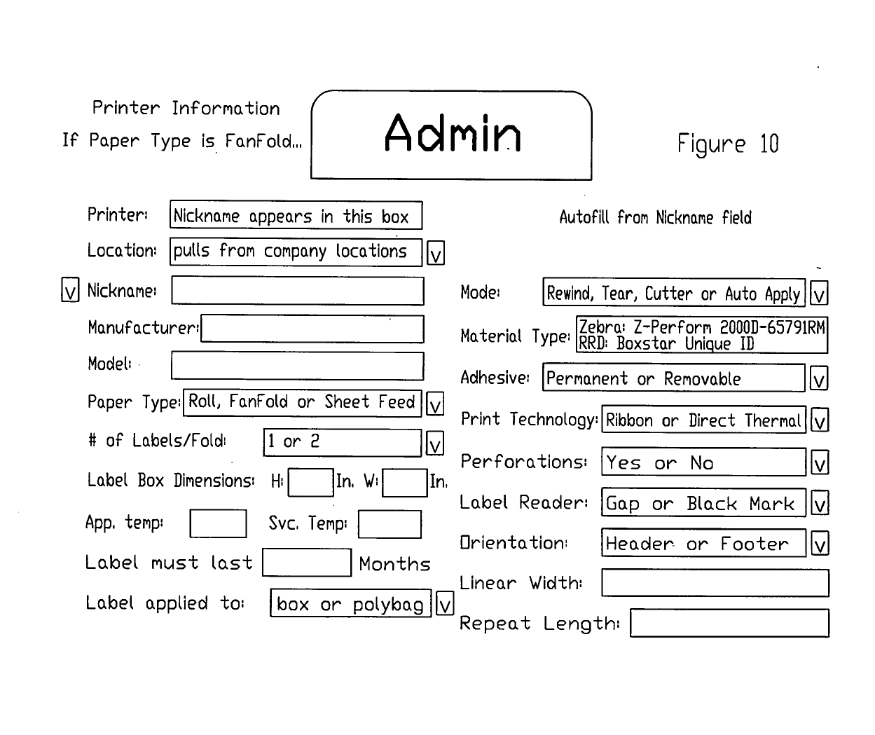

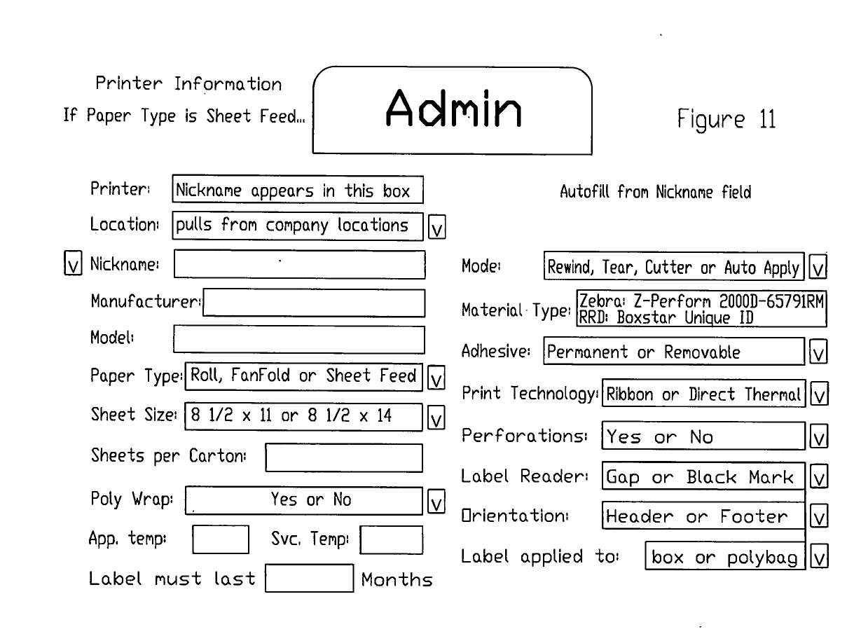

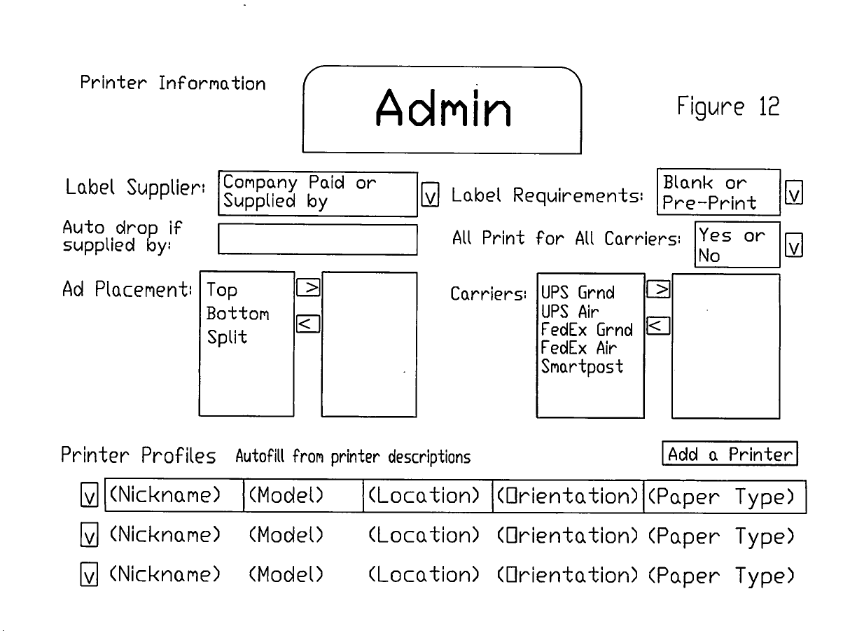

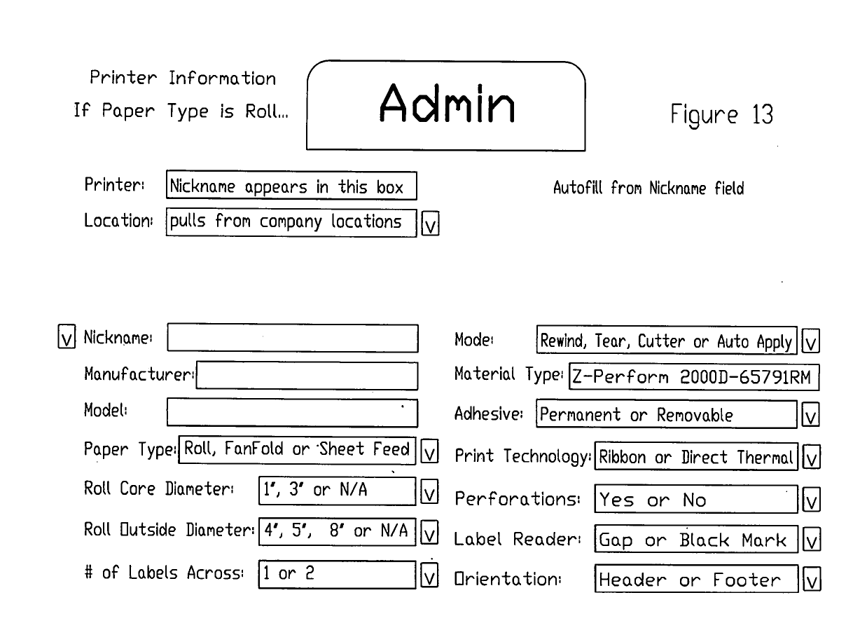

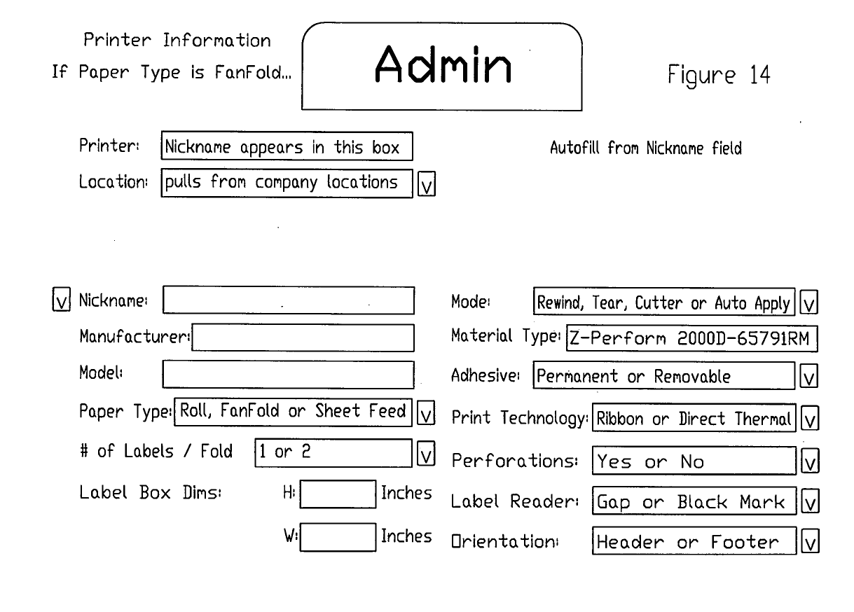

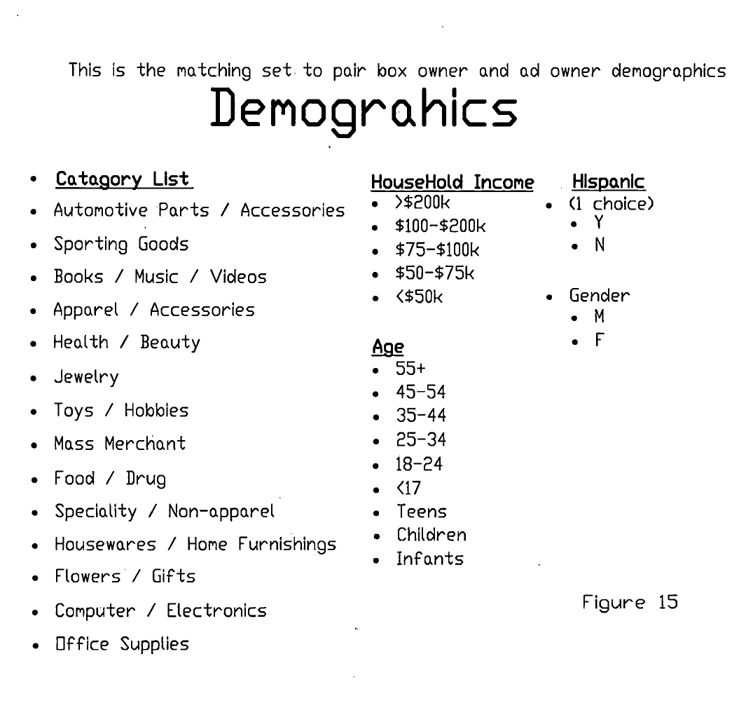

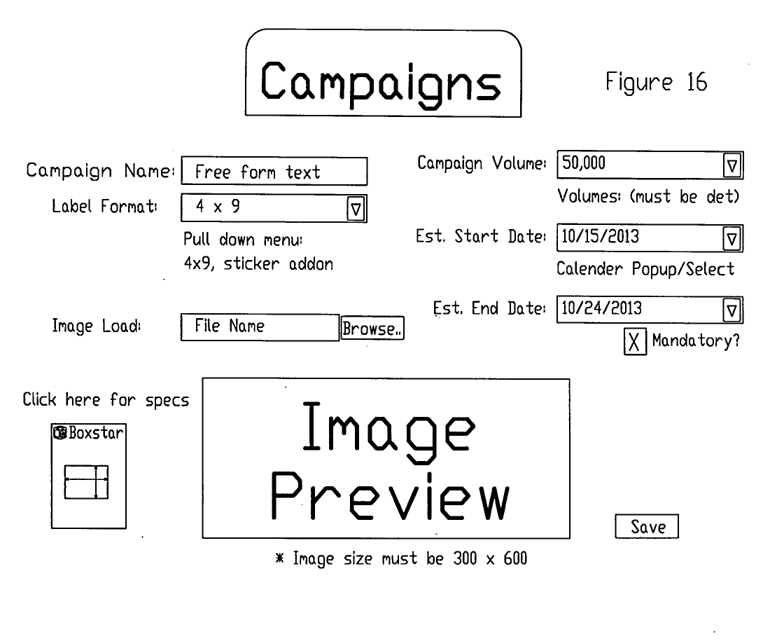

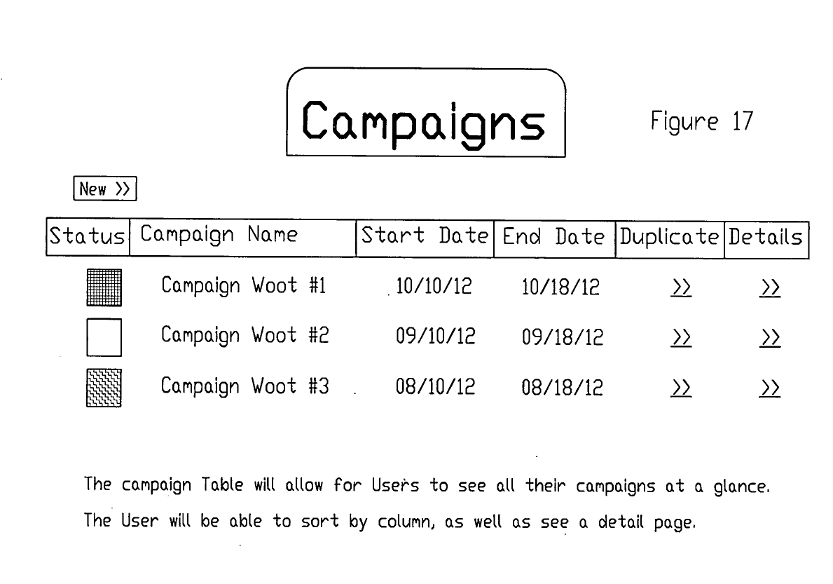

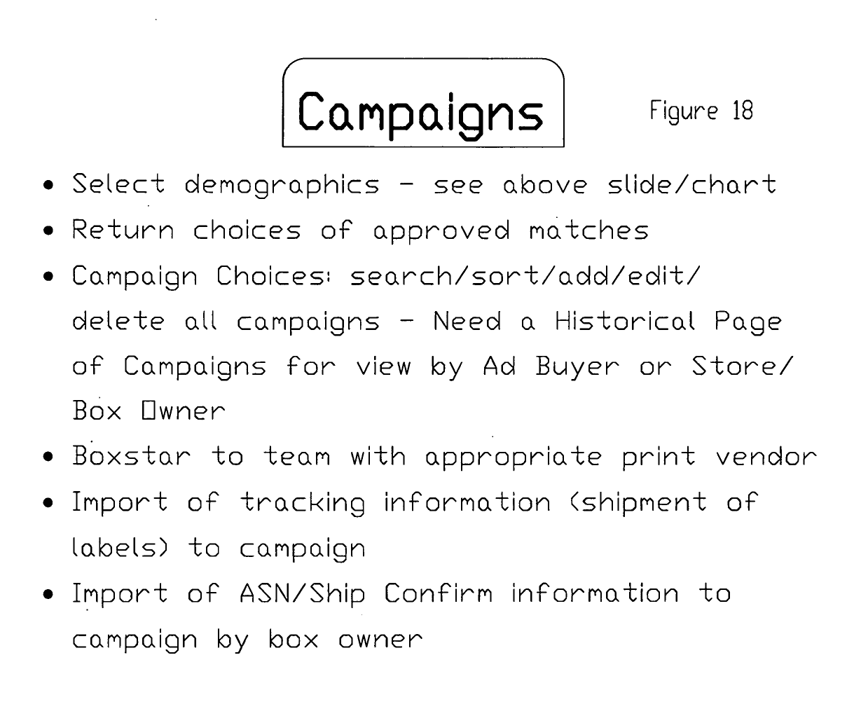

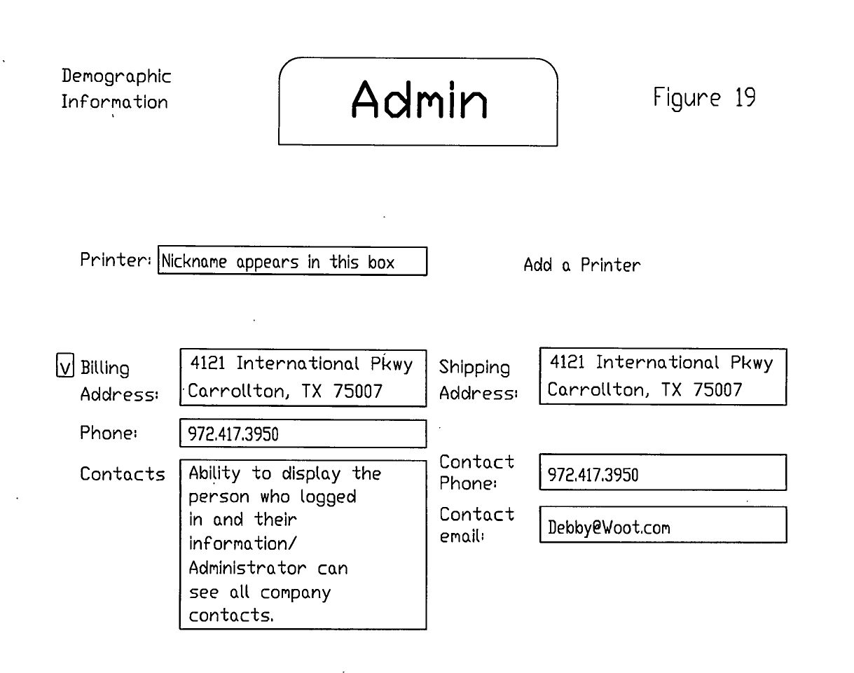

FIGS. 2-19 illustrate how methods and algorithms according to the teachings of the invention are implemented in a preferred software environment that transforms a general computing machine into a specific computing device.

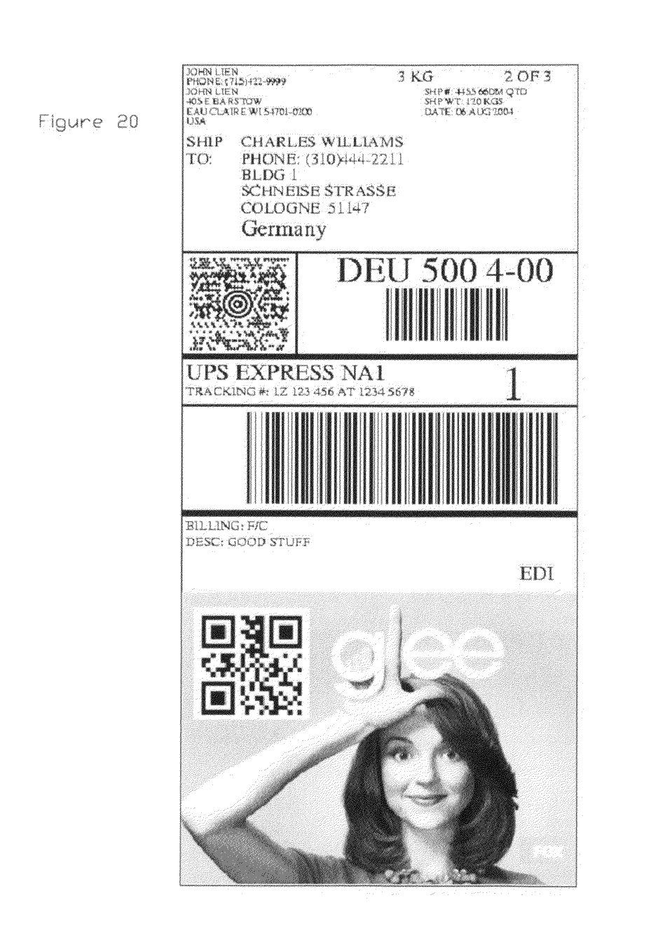

As shown in FIG. 20, the invention comprises hand-delivered to actual buyers of products highly relevant to an advertiser's brand. When consumers buy something, they often follow up with similar and related product and service purchases close to the sale. The invention helps the advertiser reach these buyers by instantly placing ads on outgoing packages containing just-sold products compatible with the advertised brand. Brands can now intercept/influence that next purchase with a message, promotion or offer on boxes delivered to known consumers who just bought a corresponding and relevant item. For example, advertisers can through the inventive platform target consumers in-home and in-office by purchase behavior and product category.

In another aspect the invention is a type of non-traditional media “hybrid.” The advertisements are place-based (such as via homes and offices), a bit like out-of-home (on the way to their destination inside the home), and delivered like direct mail. Advantages of the invention over most other media include:
Ultimately Targeted: the recipient just bought a related product yesterday, and you know what it is
Can't Be Avoided: customers can't miss the bold color, and must accept and physically handle the message
Built-in Proof-of-Performance: 99.9% Guaranteed Delivery—Thanks UPS & FedEx!
Definitely Not “Junk”: Desired, doesn't need to be opened, won't get thrown away
Quick-To-Market: Possible to be in market within 12 days
Exclusive Presentation: With magazine-quality reproduction
Multiple Impressions: From shipping, delivery, recipient, families, officemates
Smartphone Integration: Capture customer data with QR codes & social media
Buy-The-Category: books, electronics, apparel, office supplies, shoes, home improvement, etc.
Buy-The-Network: create massive brand awareness, reach online shoppers, home decision makers, heavy TV viewers, etc.
Each Delivery of an Ad is Tracked: with a unique number
React Quickly to Market Shifts/Opportunities: respond in days, not months
Implied Endorsement: by retailer and/or product manufacturer
   Recipients are in a comfortable, uncluttered environment where they make daily decisions, are near a computer and TV viewing, and excited to have received their delivered box.

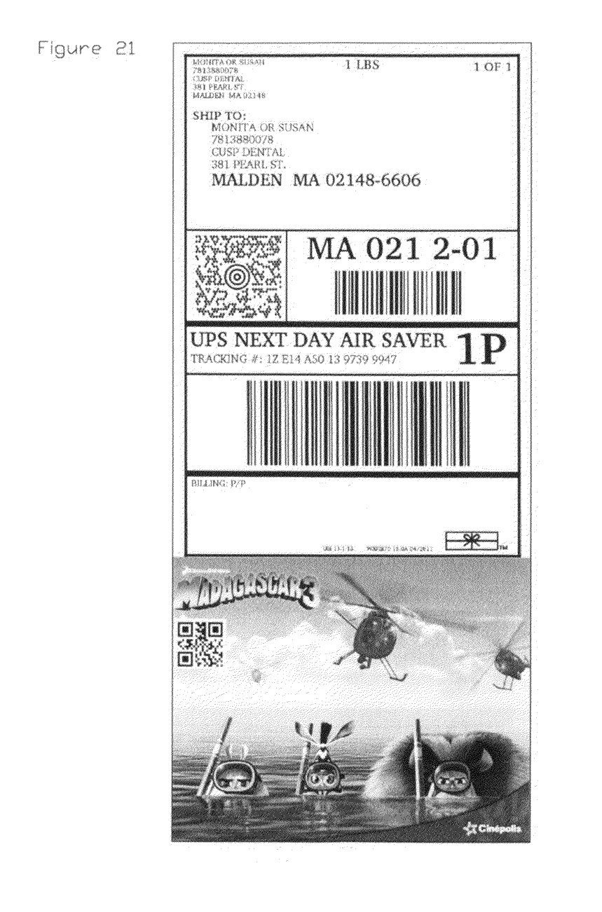

Now, turning to FIG. 21. The invention also teaches a process to save money and unlock new profits from cutomer operations with no need to hire additional staff or increase corporate overhead, by becoming a channel partner. Any website with sales can generate sales to a consumer group extremely valuable to marketers: shoppers and buyers. The profile of these buyers and what they purchase are often relevant to brands offering goods and services other than those from the primary sales website. The invention brings together channel partners, advertisers and buyers via a seamless integration of eye-catching, full-color advertisements and standard shipping labels (also known as “AdLabels”).

For each channel partner, the invention presents an outgoing package that correlates volumes to non-competing brands wishing to enhance a customer's delivery experience with relevant offers. The invention provides ads pre-printed on blank shipping labels delivered to the partner's shipping facility. Thus, the partners earn revenue just for using the printed ads in place of their current labels. For channel partners, this means savings plus ongoing income for simply doing what they are doing now. And, in a preferred embodiment, each partner retains full control of what ships with their packages (such as with a pre-approval of each advertiser and program).

Benefits include:
Receiving fees from non-competing, complimentary brands
Up-sell and cross-promote your own offers
Capture customer data with QR codes and social media integration
Re-engage buyers at the time of delivery, influence behavior, boost loyalty
Inclusion in a national network—attract leading national marketers
Consumers receive relevant ads to product within days of purchase

The invention leverages existing e-commerce distribution and sales with the technology to help e-tailers extend their reach, deepen their relationship with customers, and monetize the results. Further, the invention manages the entire promotional cycle, turn key, including; business development, sales agreements, production of creative, data capture, conversion and analytics, market research, campaign reporting, billing and disbursements, for example.

Although the invention has been described with respect to a specific preferred embodiment, many variations and modifications, including equivalents, will become apparent to those skilled in the art upon reading the present application. It is therefore the intention that the appended claims and their equivalents be interpreted as broadly as possible in view of the prior art to include all such variations and modifications.

I claim:

1. A method that converts a general computing machine into a specific computing device, comprising:
selecting an advertisement;
automatically printing bulk labels with the advertisement thereon;
associating the advertisement with at least one related item;
associating the advertisement with at least one targeted recipient; and
printing the combination of the recipient address and advertisement on a label, and automatically placing the label on the package being delivered to the recipient.
